(19) United States
(12) Patent Application Publication
(10) Pub. No.: US 2011/0244208 A1
(43) Pub. Date: Oct. 6, 2011

(54) RESIN COMPOSITION FOR LASER BEAM WELDING, ARTICLE FOR LASER BEAM WELDING, AND COMPOSITE MOLDED ARTICLE

(75) Inventors: Yuichi SAKA, Tsukuba-shi (JP); Mitsuo MAEDA, Tsukuba-shi (JP); Shintaro SAITO, Tsukuba-shi (JP)

(73) Assignee: SUMITOMO CHEMICAL COMPANY, LIMITED, Tokyo (JP)

(21) Appl. No.: 13/074,223

(22) Filed: Mar. 29, 2011

(30) Foreign Application Priority Data
Mar. 30, 2010 (JP) 2010-077289

(51) Int. Cl. B32B 27/16; C08K 7/14; C08L 81/06; B32B 27/28; B32B 27/20; B29C 65/16

(52) U.S. Cl. 428/220; 524/494; 156/272.8

(57) ABSTRACT

A resin composition for laser beam welding, including an aromatic polysulfone resin, a filler and a crystalline resin, wherein the weight ratio of the aromatic polysulfone resin to the filler being 20 to 99:80 to 1, the filler includes a glass fiber having a monofilament diameter of 10 to 50 μm, and the amount of the crystalline resin, relative to 100 parts by weight of the total of the aromatic polysulfone resin and the glass fiber being 0 to 10 parts by weight.

### TECHNICAL FIELD

The present invention relates to a resin composition for laser beam welding, an article for laser beam welding and a composite molded article.

Priority is claimed on Japanese Patent Application No. 2010-077289, filed Mar. 30, 2010, the content of which is incorporated herein by reference.

### BACKGROUND ART

Conventionally, when two thermoplastic resin articles are integrated to obtain a composite molded article, for stably welding the thermoplastic resin articles together with a high strength by laser beam welding, it has been known that a transmission-side weld material (thermoplastic resin article) is required to have a satisfactory laser transmittance (for example, see Patent Documents 1 and 2).

Further, it has been disclosed to add a filler to a crystalline resin (polyphenylene sulfide resin) having excellent mechanical properties and heat resistance for the sake of reinforcement (for example, refer to Patent Document 3).

### DOCUMENTS OF RELATED ART

### Patent Document

[Patent Document 1] Japanese Unexamined Patent Application, First Publication No. Sho 60-214931
[Patent Document 2] Japanese Unexamined Patent Application, First Publication No. Sho 62-142092
[Patent Document 3] Japanese Unexamined Patent Application, First Publication No. 2005-15792 (paragraphs [0002] and [0039])

### SUMMARY OF THE INVENTION

However, in the laser beam welding process, since the crystalline resin or the filler may cause a reduction in the laser transmittance of an article for laser beam welding, it is not always possible to achieve a satisfactory level of laser transmittance depending on the usage of the article for laser beam welding.

Moreover, when the thermoplastic resin articles are laser welded, and especially in those cases where the thickness of a transmission-side weld material exceeds 2 mm, the laser transmittance of an article for laser beam welding reduces as the thickness increases. As a result, the amount of heat input to the welded portion reduces, which inevitably makes the welding strength insufficient. On the other hand, if the laser output is increased so as to compensate for the reduced heat input, the transmission-side weld material absorbs the laser beam before the laser beam reaches the welded portion, which may deteriorate the outer appearance due to discoloration or cause smoking and ignition.

Accordingly, in view of such circumstances, an object of the present invention is to provide a resin composition for laser beam welding that is capable of retaining the laser transmittance necessary for the laser beam welding even if a filler or a crystalline resin is included, and is consequently capable of preventing deterioration of the outer appearance, due to the discoloration of transmission-side weld material, or smoking/ignition which is caused by an increase in the laser output; an article for laser beam welding; and a composite molded article.

In order to achieve such an object, the inventors of the present invention focused on the study to specify the diameter and refractive index of the glass fiber included in the resin composition for laser beam welding as a filler and also to set the upper limit for the addition of a crystalline resin which causes a reduction in the laser transmittance, for the sake of improving the laser transmittance of an article for laser beam welding, thereby completing the present invention.

That is, the present invention is (1) a resin composition for laser beam welding, including an aromatic polysulfone resin and a filler with an aromatic polysulfone resin/filler weight ratio in the range of 20/80 to 99/1, and characterized in that the filler is a glass fiber having a monofilament diameter of 10 to 50 μm, and 0 to 10 parts by weight of a crystalline resin is added, relative to 100 parts by weight of the total of the aromatic polysulfone resin and the glass fiber.

In the present invention, in addition to the constituent feature described above in (1), it is preferable that (2) the glass fiber has a refractive index of 1.4 to 1.8.

Moreover, in the present invention, in addition to the constituent feature described above in (1) or (2), it is preferable that (3) the resin composition for laser beam welding further includes 0.01 to 1 part by weight of a lubricant, relative to 100 parts by weight of the total of the aromatic polysulfone resin and the glass fiber.

Further, the present invention is characterized by: (4) an article for laser beam welding including the resin composition for laser beam welding described above in any one of (1) to (3) and having a thickness of 0.5 to 6 mm.

Furthermore, the present invention is characterized by: (5) a composite molded article obtainable by contacting a transmission-side weld material with an absorption-side weld material, and irradiating a laser beam through the transmission-side weld material to the interface between the transmission-side weld material and the absorption-side weld material to thereby laser weld the transmission-side weld material and the absorption-side weld material, the composite molded article using an article for laser beam welding which includes the resin composition for laser beam welding described above in any one of (1) to (3) as the transmission-side weld material.

According to the present invention, since the diameter and refractive index of the glass fiber included in the resin composition for laser beam welding as a filler have been specified and also the upper limit for the addition of a crystalline resin has been set, the level of laser transmittance necessary for the laser beam welding can be maintained even if a filler or a crystalline resin is included.

Accordingly, it is possible to secure the amount of heat input to the welded portion between the transmission-side weld material and the absorption-side weld material without increasing the laser output. For this reason, it becomes possible to prevent deterioration of the outer appearance, due to the discoloration of transmission-side weld material, or smoking/ignition which is caused by an increase in the laser output.

### BRIEF DESCRIPTION OF THE DRAWINGS

FIG. 1A is a perspective view and FIG. 1B is an enlarged cross sectional view, showing a composite molded article according to a first embodiment of the present invention.

FIGS. 2A and 2B is a process chart indicating a method for measuring laser transmittance.

### DETAILED DESCRIPTION OF THE INVENTION

Embodiments of the present invention will be described below.

### First Embodiment of the Invention

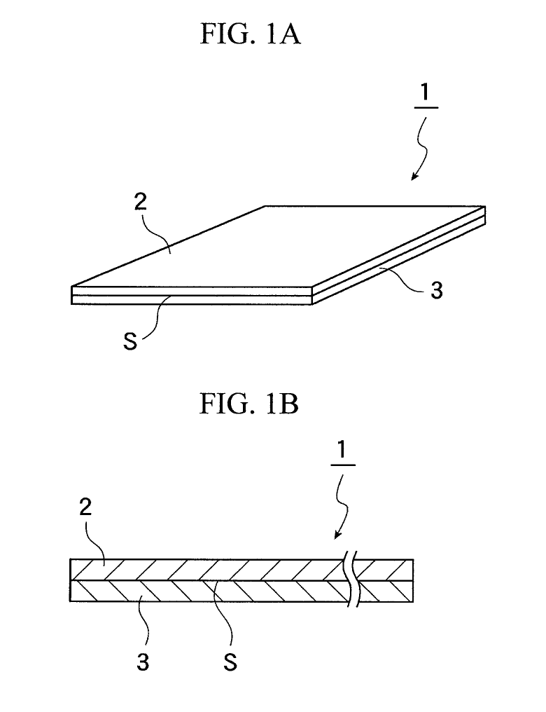

FIG. 1 shows a first embodiment of the present invention.

A composite molded article 1 according to the first embodiment is formed by integrally bonding a transmission-side weld material 2 and an absorption-side weld material 3 through laser beam welding at the interface S between the both materials, as shown in FIG. 1.

In producing the composite molded article 1, the transmission-side weld material 2 and the absorption-side weld material 3 are brought into contact, and a laser beam is irradiated through the transmission-side weld material 2 onto the interface S between the two materials, thereby laser beam welding the transmission-side weld material 2 and the absorption-side weld material 3.

The transmission-side weld material 2 is constituted of an article for laser beam welding, and the thickness of the article for laser beam welding is 0.5 to 6 mm (and preferably 1 to 3 mm). When the thickness is less than 0.5 mm, problems arise not only in the mechanical strength and the handling properties, but also in the fluidity during molding, which make it difficult to mold large-sized components. On the other hand, when the thickness exceeds 6 mm, a laser energy level which is required for the welding process cannot be achieved since the laser transmittance of the article for laser beam welding reduces.

The article for laser beam welding can be molded from a resin composition for laser beam welding, which is composed of an aromatic polysulfone resin (polyether sulfone), a glass fiber (filler) and a lubricant, by various molding methods, such as injection molding, compression molding, extrusion molding and blow molding.

The aromatic polysulfone resin refers to a repeating structural unit which essentially contains an arylene unit, an ether bond and a sulfone bond, and is a polyarylene compound having a refractive index of about 1.65, in which the arylene unit as well as the ether bond and the sulfone bond is positioned in order or in disorder.

This aromatic polysulfone resin is an aromatic polysulfone resin having a melt viscosity of 200 to 1,000 Pa·s (preferably 200 to 700 Pa·s and more preferably 300 to 500 Pa·s), as measured at 340° C. and a shear rate of 1,000 s⁻¹. When the melt viscosity of the aromatic polysulfone resin is less than 200 Pa·s, the strength of the article for laser beam welding is reduced sometimes. On the other hand, when the melt viscosity of the aromatic polysulfone resin exceeds 1,000 Pa·s, the fluidity of the resin composition during molding may deteriorate.

Examples of the structural unit for this aromatic polysulfone resin include those represented by the following general formulas (I), (II) and (III).

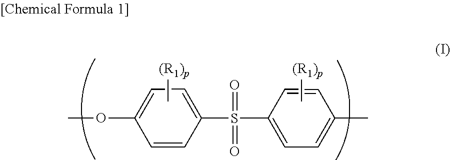

(In formula (I), R₁ represents an alkyl group of 1 to 6 carbon atoms, an alkenyl group of 3 to 10 carbon atoms, a phenyl group or a halogen atom, and p represents an integer of 0 to 4. Each R₁ on the same or different nucleus may be the same or different from each other. Each p may be the same or different from each other.)

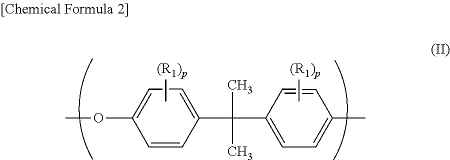

(In formula (II), R₁ and p are the same as defined above in formula (I).)

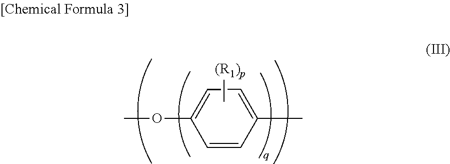

(In formula (III), R₁ and p are the same as defined above in formula (I), and q represents an integer of 1 to 3.)

When the aromatic polysulfone resin is composed of the structural unit (I), it is preferable that p in the structural unit (I) be 0, and it is particularly desirable that the resin contain the structural unit (I) by 80 mol % or more. Further, when the aromatic polysulfone resin is composed of the structural unit (I) and the structural unit (II), the structural unit (I)/structural unit (II) molar ratio is generally 0.5 to 50, preferably 0.5 to 9, and more preferably 0.5 to 4. Furthermore, when the aromatic polysulfone resin is composed of the structural unit (I) and the structural unit (III), it is preferable that q in the structural unit (III) be 1 or 2, and the structural unit (I)/structural unit (III) molar ratio is generally 0.1 to 20, preferably 0.1 to 9, and more preferably 0.5 to 4.

Of the various possibilities, those composed of the structural unit (I), or those composed of the structural unit (I) and the structural unit (II) are preferred, and those composed of the structural unit (I) are more preferred.

A conventional method can be adopted as a method for producing the aromatic polysulfone resin. In addition, as the aromatic polysulfone resins composed of the structural unit (I), examples of commercially available aromatic polysulfone resins include SUMIKAEXCEL PES 3600P and SUMIKAEXCEL PES 4100P manufactured by Sumitomo Chemical Co., Ltd. Further, as the aromatic polysulfone resins composed of both the structural unit (I) and the structural unit (II), examples thereof include UDEL P-1700 manufactured by Amoco Polymers Inc. Moreover, the terminal structure thereof is determined in accordance with the production method of each resin, and examples thereof include —Cl, —OH and —OR (where R represents an alkyl group).

The glass fiber is a fiber having a monofilament diameter of 10 to 50 μm (preferably 17 to 50 μm, and more preferably 23 to 50 μm), and a refractive index of 1.4 to 1.8 (preferably, the difference from the refractive index of aromatic polysulfone resin, which is about 1.65, is 0.2 or less). When the monofilament diameter of the glass fiber is less than 10 μm, the laser transmittance reduces. On the other hand, when the monofilament diameter of the glass fiber exceeds 50 μm, the strength of the article for laser beam welding reduces.

The mixing ratio (weight ratio) of the aromatic polysulfone resin to the glass fiber is in the range of 20/80 to 99/1 (preferably in the range of 50/50 to 88/12). When the amount of glass fiber increases relative to that of the aromatic polysulfone resin, the laser transmittance reduces. On the other hand, when the amount of glass fiber is too low relative to that of the aromatic polysulfone resin, it is difficult to achieve a desired level of strength.

The lubricant is at least one material selected from propylene glycol fatty acid ester-based compounds, sorbitan fatty acid ester-based compounds, and glycerin fatty acid ester-based compounds.

The amount of lubricant to be added is 0.01 to 1 part by weight (and preferably 0.05 to 1 part by weight), relative to 100 parts by weight of the total of the aromatic polysulfone resin and the glass fiber. When the amount of lubricant added is less than 0.01 part by weight, the effects of preventing color development during granulation and molding will be inadequate. On the other hand, if the amount of lubricant added exceeds 1 part by weight, it is undesirable since the smoking may occur, contamination of the mold surface may be observed, the article for laser beam welding may become opaque, and the physical properties such as the impact strength may deteriorate.

Further, the absorption-side weld material 3 is constituted of an article for laser beam welding, which is prepared by adding a laser absorbing material such as carbon black, carbon fibers and laser absorbing dyes to the absorption-side weld material 2.

As described above, in the resin composition for laser beam welding, which is a raw material for the article for laser beam welding constituting the transmission-side weld material 2 and the absorption-side weld material 3, since the diameter of the glass fiber is specified, scattering of the laser beam can be reduced, as compared to the case where the glass fibers with smaller diameters are used. As a result, it becomes possible to improve the laser transmittance of the article for laser beam welding.

In addition, in the resin composition for laser beam welding, since the refractive index of the glass fiber is set to a value close to the refractive index of the aromatic polysulfone resin, straightness of the laser beam can be improved. As a result, it becomes possible to improve the laser transmittance of the article for laser beam welding.

Accordingly, in the laser beam welding between the transmission-side weld material 2 and the absorption-side weld material 3, it is possible to secure the amount of heat input to the welded portion between the transmission-side weld material 2 and the absorption-side weld material 3 without increasing the laser output. For this reason, it becomes possible to prevent deterioration of the outer appearance, due to the discoloration of transmission-side weld material 2, or smoking/ignition which is caused by an increase in the laser output. As a result, the yield of the composite molded article 1 as well as the safety at work can be enhanced when producing the composite molded article 1.

### Other Embodiments of the Invention

Although a resin composition for laser beam welding which is composed of three components (i.e., an aromatic polysulfone resin, a glass fiber and a lubricant) has been described above in the first embodiment, it should be noted that a small amount (specifically, 10 parts by weight or less, relative to 100 parts by weight of the total of the aromatic polysulfone resin and the glass fiber) of crystalline resin may be added thereto. In this case, because the added amount of crystalline resin which may cause a reduction in the laser transmittance is small, a significant reduction in the laser transmittance of the article for laser beam welding can be avoided.

Moreover, although the case where a glass fiber is included as one of the components in the resin composition for laser beam welding has been described above in the first embodiment, it is also possible to add a filler other than the glass fiber (for example, a fibrous or acicular reinforcing material such as an aluminum fiber, a silica alumina fiber, an alumina fiber or an aluminum borate whisker; and an inorganic filler such as talc, mica, calcium carbonate, silica, clay, magnesium carbonate, barium sulfate, alumina, glass flakes and glass beads).

Furthermore, although the case where a lubricant is included as one of the components in the resin composition for laser beam welding has been described above in the first embodiment, an additive other than the lubricant (for example, a mold release agent, such as a fluorine resin or a metal soap; a colorant such as a pigment (e.g., titanium oxide) or a dye; an antioxidant; a heat stabilizer; an ultraviolet absorber; an antistatic agent; and a surfactant) may be added as a component of the resin composition for laser beam welding. When 0.01 to 1 part by weight of a heat stabilizer such as a phenol-based compound, a sulfur-based compound or a phosphorus-based compound is added, relative to 100 parts by weight of the total of the aromatic polysulfone resin and the glass fiber, the color development or reduction in the transmittance during granulation and molding can be prevented.

### EXAMPLES

As follows is a description of examples of the present invention, although the scope of the present invention is by no way limited by these examples.

### Example 1

A pellet constituted of a resin composition for laser beam welding was prepared by mixing 80 parts by weight of an aromatic polysulfone resin SUMIKAEXCEL PES 3600P (glass transition temperature Tg=225° C.) manufactured by Sumitomo Chemical Co., Ltd. and 20 parts by weight of a glass fiber CS03JAPx-1 (having a monofilament diameter of 10 μm and a refractive index of 1.56) manufactured by Owens Corning Japan Ltd., and following the addition of 0.2 parts by weight of triphenyl phosphate manufactured by Wako Pure Chemical Industries, Ltd. as a heat stabilizer relative to 100 parts by weight of the mixture, melting and kneading the resultant using a twin screw extruder PCM-30 manufactured by Ikegai Corp. In terms of the conditions for melting and kneading during this process, a cylinder preset temperature of the twin screw extruder was set to 330° C., and the screw rotational speed was set to 150 rpm. Here, the cylinder preset temperature refers to an average value of the preset temperatures of the heating equipment installed from the bottom of the cylinder up to the part that corresponds to about ⅔ of the cylinder length. The compositions are shown in Table 1.

### Example 2

A pellet constituted of a resin composition for laser beam welding was prepared in the same manner as described above in Example 1 with the exception that a glass fiber CS03MAFT692 (having a monofilament diameter of 13 μm and a refractive index of 1.56) manufactured by Owens Corning Japan Ltd. was used instead. The compositions are shown in Table 1.

### Example 3

A pellet constituted of a resin composition for laser beam welding was prepared in the same manner as described above in Example 1 with the exception that a glass fiber ECS03T-747 (having a monofilament diameter of 17 μm and a refractive index of 1.5) manufactured by Nippon Electric Glass Co., Ltd. was used instead. The compositions are shown in Table 1.

### Example 4

A pellet constituted of a resin composition for laser beam welding was prepared in the same manner as described above in Example 1 with the exception that a glass fiber CS03TAFT692 (having a monofilament diameter of 23 μm and a refractive index of 1.56) manufactured by Owens Corning Japan Ltd. was used instead. The compositions are shown in Table 1.

### Example 5

A pellet constituted of a resin composition for laser beam welding was prepared by mixing 70 parts by weight of an aromatic polysulfone resin SUMIKAEXCEL PES 3600P (glass transition temperature Tg=225° C.) manufactured by Sumitomo Chemical Co., Ltd. and 30 parts by weight of a glass fiber CS03JAPx-1 (having a monofilament diameter of 10 μm and a refractive index of 1.56) manufactured by Owens Corning Japan Ltd., and following the addition of 0.2 parts by weight of triphenyl phosphate manufactured by Wako Pure Chemical Industries, Ltd. as a heat stabilizer relative to 100 parts by weight of the mixture, melting and kneading the resultant using a twin screw extruder PCM-30 manufactured by Ikegai Corp. In terms of the conditions for melting and kneading during this process, a cylinder preset temperature of the twin screw extruder was set to 330° C., and the screw rotational speed was set to 150 rpm. Here, the cylinder preset temperature refers to an average value of the preset temperatures of the heating equipment installed from the bottom of the cylinder up to the part that corresponds to about ⅔ of the cylinder length. The compositions are shown in Table 1.

### Example 6

A pellet constituted of a resin composition for laser beam welding was prepared in the same manner as described above in Example 5 with the exception that a glass fiber CS03MAFT692 (having a monofilament diameter of 13 μm and a refractive index of 1.56) manufactured by Owens Corning Japan Ltd. was used instead. The compositions are shown in Table 1.

### Example 7

A pellet constituted of a resin composition for laser beam welding was prepared in the same manner as described above in Example 5 with the exception that a glass fiber ECS03T-747 (having a monofilament diameter of 17 μm and a refractive index of 1.5) manufactured by Nippon Electric Glass Co., Ltd. was used instead. The compositions are shown in Table 1.

### Example 8

A pellet constituted of a resin composition for laser beam welding was prepared in the same manner as described above in Example 5 with the exception that a glass fiber CS03TAFT692 (having a monofilament diameter of 23 μm and a refractive index of 1.56) manufactured by Owens Corning Japan Ltd. was used instead. The compositions are shown in Table 1.

### Example 9

A pellet constituted of a resin composition for laser beam welding was prepared in the same manner as described above in Example 8 with the exception that 0.1 parts by weight of glycerol tristearate was further added as a lubricant, relative to 100 parts by weight of the mixture of the aromatic polysulfone resin and the glass fiber. The compositions are shown in Table 1.

### Comparative Example 1

A pellet constituted of a resin composition for laser beam welding was prepared in the same manner as described above in Example 1 with the exception that a glass fiber 03DE FT791A (having a monofilament diameter of 6 μm and a refractive index of 1.56) manufactured by Owens Corning Japan Ltd. was used instead. The compositions are shown in Table 1.

### Comparative Example 2

A pellet constituted of a resin composition for laser beam welding was prepared in the same manner as described above in Example 5 with the exception that a glass fiber 03DE FT791A (having a monofilament diameter of 6 μm and a refractive index of 1.56) manufactured by Owens Corning Japan Ltd. was used instead. The compositions are shown in Table 1.

TABLE 1

| | Thermoplastic | | |
|---|---|---|---|
| | resin | Filler (filler diameter, parts | |
| | (parts by weight) | by weight) | Additive |
| Ex. 1 | Aromatic | Glass fiber (10 μm, 20) | Heat stabilizer |
| | polysulfone | | |
| | resin (80) | | |
| Ex. 2 | Aromatic | Glass fiber (13 μm, 20) | Heat stabilizer |
| | polysulfone | | |
| | resin (80) | | |
| Ex. 3 | Aromatic | Glass fiber (17 μm, 20) | Heat stabilizer |
| | polysulfone | | |
| | resin (80) | | |
| Ex. 4 | Aromatic | Glass fiber (23 μm, 20) | Heat stabilizer |
| | polysulfone | | |
| | resin (80) | | |
| Ex. 5 | Aromatic | Glass fiber (10 μm, 30) | Heat stabilizer |
| | polysulfone | | |
| | resin (70) | | |
| Ex. 6 | Aromatic | Glass fiber (13 μm, 30) | Heat stabilizer |
| | polysulfone | | |
| | resin (70) | | |
| Ex. 7 | Aromatic | Glass fiber (17 μm, 30) | Heat stabilizer |
| | polysulfone | | |
| | resin (70) | | |
| Ex. 8 | Aromatic | Glass fiber (23 μm, 30) | Heat stabilizer |
| | polysulfone | | |
| | resin (70) | | |
| Ex. 9 | Aromatic | Glass fiber (23 μm, 30) | Heat stabilizer, |
| | polysulfone | | lubricant |
| | resin (70) | | |
| Comp. | Aromatic | Glass fiber (6 μm, 20) | Heat stabilizer |
| Ex. 1 | polysulfone | | |
| | resin (80) | | |
| Comp. | Aromatic | Glass fiber (6 μm, 20) | Heat stabilizer |
| Ex. 2 | polysulfone | | |
| | resin (70) | | |

### <Measurement of Laser Transmittance of Article for Laser Beam Welding>

In order to examine the effects of the thickness of the article for laser beam welding, the monofilament diameter of the glass fiber, and the presence/absence of lubricant, on the laser transmittance of the article for laser beam welding, three types of flat plate samples (articles for laser beam welding, 64 mm×64 mm) with different thicknesses (1 mm, 3 mm and 5 mm) were molded by injection molding using an electric molding machine ES400 manufactured by Nissei Plastic Industrial Co., Ltd. in the respective Examples 1 to 9 and Comparative Examples 1 and 2, and the laser transmittance of each sample was measured by the following procedures.

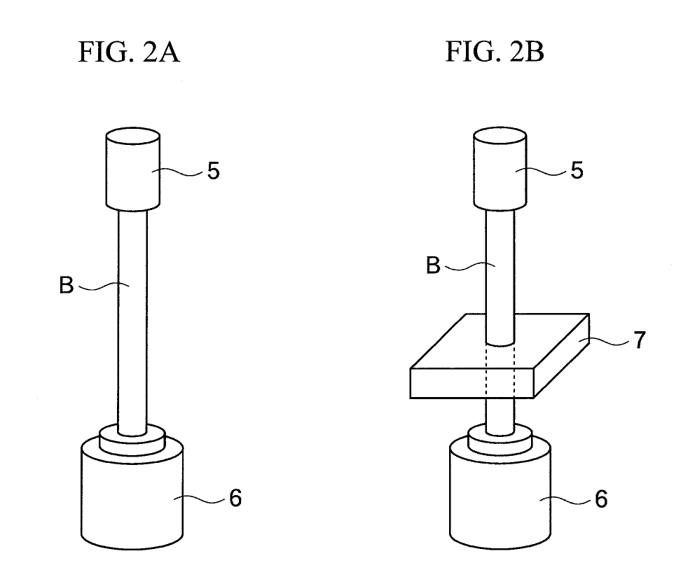

Firstly, as shown in FIG. 2A, a laser beam B with a wavelength of 940 nm was oscillated with an output of 5 W using a laser oscillator 5 manufactured by Fine Device Co., Ltd., and energy E1 was measured with a power meter 6 manufactured by Ophir Optronics Ltd. Next, as shown in FIG. 2B, a sample 7 was held between the laser oscillator 5 and the power meter 6 so as to become perpendicular to the traveling direction of the laser beam B, and under such a condition, a laser beam B of the same wavelength was oscillated with the same output from the laser oscillator 5, and energy E2 was measured with the power meter 6. Then, the laser transmittance (unit: %) of sample 7 was calculated by determining the ratio of energy E2 to energy E1.

The results are summarized in Table 2.

TABLE 2

| | Laser transmittance (%) | | |
|---|---|---|---|
| | 1 mm thickness | 3 mm thickness | 5 mm thickness |
| Example. 1 | 61 | 34 | 22 |
| Example. 2 | 64 | 37 | 24 |
| Example. 3 | 68 | 40 | 26 |
| Example. 4 | 73 | 44 | 29 |
| Example. 5 | 54 | 28 | 18 |
| Example. 6 | 54 | 29 | 19 |
| Example. 7 | 62 | 30 | 19 |
| Example. 8 | 63 | 34 | 23 |
| Example. 9 | 63 | 36 | 24 |
| Comparative | 54 | 33 | 22 |
| Example. 1 | | | |
| Comparative | 45 | 25 | 14 |
| Example. 2 | | | |

As is apparent by comparing Examples 1 to 4 and Comparative Example 1 in Table 2, it became evident that when the mixing ratio of the aromatic polysulfone resin and the glass fiber was 80 (parts by weight):20 (parts by weight), the laser transmittance of the article for laser beam welding improved as the monofilament diameter of the glass fiber increased, regardless of the sample thickness. Moreover, also when the mixing ratio of the aromatic polysulfone resin and the glass fiber was 70 (parts by weight):30 (parts by weight), as is apparent by comparing Examples 5 to 8 and Comparative Example 2, it became evident that the laser transmittance of the article for laser beam welding improved as the monofilament diameter of the glass fiber increased, regardless of the sample thickness.

Furthermore, from the comparison between Example 8 and Example 9, it became clear that the laser transmittance of the article for laser beam welding improved when a lubricant had been added to the resin composition for laser beam welding.

### INDUSTRIAL APPLICABILITY

The article for laser beam welding according to the present invention can be widely applied to, for example, electric and electronic parts, such as a connector, a socket, a relay part, a coil bobbin, an optical pick-up, a radiator, a printed wiring board and computer associated parts; semiconductor production process associated parts, such as an IC tray and a wafer carrier; household electrical appliance parts, such as a VTR, a television, an iron, an air conditioner, a stereo, a vacuum cleaner, a refrigerator, a rice cooker and lighting; lighting parts, such as a lamp reflector and a lamp holder; acoustic product parts, such as a compact disc, a laser disc (registered trademark) and a speaker; communication equipment parts, such as a ferrule for an optical cable, a telephone part, a facsimile part and a modem; copying machine associated parts, such as a separation claw and a heater holder; mechanical parts, such as an impeller, a fan, a toothed wheel, a gear, a bearing, and a motor part and a case thereof; vehicle parts, such as a vehicle mechanism part, an engine part, a cell part, an engine room interior part, electric equipment parts, interior parts, and pumping parts, such as an air intake manifold, an intercooler inlet and an exhaust pipe cover; cookware, such as a microwave cooking pot and a thermal resistant plate; constructional materials or civil engineering materials, such as a flooring material, a thermal insulant or sound-proof material for a wall material, a support material such as a beam or a pillar and a roof material; air craft parts; space craft parts; parts for a radiation facility such as a nuclear reactor; parts for an oceanic facility; a washing jig; optical appliance parts; valves; pipes; nozzles; filters; membranes; medical appliance parts and medical materials; parts for sensors; sanitary equipments; sports goods; and leisure goods.

Further, the composite molded article according to the present invention can be suitably used as a large-sized molded article with a thickness exceeding 2 mm, and examples thereof include materials, especially the vehicle parts, such as a fuel tank and a cell part, to run or to maintain a liquid internally.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A resin composition for laser beam welding, comprising an aromatic polysulfone resin, a filler and a crystalline resin,
the weight ratio of the aromatic polysulfone resin to the filler being in the range of 20/80 to 99/1,
the filler comprising a glass fiber having a monofilament diameter of 10 to 50 μm, and
the amount of the crystalline resin, relative to 100 parts by weight of the total of the aromatic polysulfone resin and the glass fiber being 0 to 10 parts by weight.

2. The resin composition for laser beam welding according to claim 1, wherein the glass fiber has a refractive index of 1.4 to 1.8.

3. The resin composition for laser beam welding according to claim 1, which further comprises 0.01 to 1 part by weight of a lubricant, relative to 100 parts by weight of the total of the aromatic polysulfone resin and the glass fiber.

4. An article for laser beam welding comprising the resin composition for laser welding according to claim 1 and having a thickness of 0.5 to 6 mm.

5. A composite molded article obtainable by contacting a transmission-side weld material with an absorption-side weld material, and irradiating a laser through the transmission-side weld material to the interface between the transmission-side weld material and the absorption-side weld material to thereby weld the transmission-side weld material and the absorption-side weld material,
the transmission-side weld material being a laser beam welding article comprising the resin composition for laser beam welding according to claim 1.
